(19) United States
(12) Patent Application Publication
(10) Pub. No.: US 2019/0133317 A1
(43) Pub. Date: May 9, 2019

(54) SECRET STORAGE DRESSER

(71) Applicant: Taneshia Pawelczak, Middle Village, NY (US)

(72) Inventor: Taneshia Pawelczak, Middle Village, NY (US)

(21) Appl. No.: 16/183,705

(22) Filed: Nov. 7, 2018

Related U.S. Application Data
(60) Provisional application No. 62/582,648, filed on Nov. 7, 2017.

(51) Int. Cl. A47B 67/04; A47B 55/00; A47B 88/919; E05B 65/46; G07C 9/00

(52) U.S. Cl. CPC A47B 67/04; A47B 55/00; G07C 9/00563; E05B 65/46; A47B 88/919

(57) ABSTRACT

A dresser for discretely securing items; the dresser for discretely securing items therein includes a housing having at least two visible drawers therein, a dresser-top having at least one hidden drawer therein, a latch-mechanism and an opener. In one embodiment, the opener is a lock and key. In another embodiment, the opener is a fingerprint scanner. The dresser provides a safe, secured, discreet way to store personal belongings of value, including money and jewelry.

### CROSS REFERENCE TO RELATED APPLICATION

The present application is related to and claims priority to U.S. Provisional Patent Application No. 62/582,648 filed Nov. 7, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of furniture and more specifically relates to a dresser with a secret storage compartment.

### 2. DESCRIPTION OF RELATED ART

When a house is burglarized the most likely targets of theft are those having relatively small size and weight, but high monetary value. For obvious reasons, a thief is more inclined to take jewelry, other precious metals, cash, etc., in favor of larger and heavier items which are more difficult to transport and conceal. As such, people are always looking for inconspicuous ways to store their valuable personal belongings around a home. Some people may invest in a safe, but such storage methods can be expensive, obvious, and aren't practical for everyone. Additionally, small safes can be removed from a home. Some people may hide their belongings in different, unsuspecting places, but it can be a hassle to find these belongings when they're needed. A suitable solution is desired.

U.S. Pat. No. 5,944,396 to Gerald H. Stephan relates to furniture having a concealed drawer with a dual stage locking mechanism. The described furniture having a concealed drawer with a dual stage locking mechanism includes a front drawer that is revealed. The front drawer is received within a receptacle defined by a lateral partition disposed proximately at the center of the furniture and a pair of oppositely disposed side aprons. The lateral partition serves to hide the concealed drawer in the event the front drawer is removed. A stop is pivotally mounted to the upper end of the back wall of the front drawer in order to limit the forward travel of the front drawer out of the receptacle. A first locking mechanism includes a push-button, key-operated lock which is locked simply by pushing a button and is unlocked using a key. The first locking mechanism may be disposed on either the bottom of the furniture or on the lateral interior partition of the furniture. A second locking mechanism consists of a magnetically operated lock configured to open when a magnet of an opposite pole from a magnet incorporated in the second locking mechanism is placed near the second locking mechanism.

### BRIEF SUMMARY OF THE INVENTION

In view of the foregoing disadvantages inherent in the known furniture art, the present disclosure provides a novel secret storage dresser. The general purpose of the present disclosure, which will be described subsequently in greater detail, is to provide a safe, secured, discreet way to store personal belongings of value, including money and jewelry.

A dresser is disclosed herein. The dresser includes a housing which may include a first inner-capacity defined by a bottom-surface relative to a floor-surface, a first-side wall, a second-side wall opposite the first side-wall, a rear-wall, and a first open-front opposite the rear-wall. The first inner-capacity may be configured to slidably-receive at least two visible drawers via the first open-front. A dresser-top may be attached to a top of the housing and may include a second inner-capacity defined by a top-surface, a first side-surface, a second side-surface opposite the first side-surface, a rear-surface and a second open-front opposite the rear-surface. The second inner-capacity may be configured to slidably-receive at least one hidden drawer via the second open-front.

A latch-mechanism may be attached to an inner-surface of the dresser-top and in communication with the at least one hidden drawer. The latch-mechanism may be configured to selectively lock and unlock the at least one hidden drawer within the second inner-capacity. Further, an opener may be attached to the dresser-top and in communication with the latch-mechanism. The opener may be configured to actuate the latch-mechanism to selectively unlock the at least one hidden drawer.

A method of using dresser is also disclosed herein. The method of using the dresser may comprise the steps of: providing the dresser as above; using the opener to actuate the latch-mechanism to selectively unlock the at least one hidden drawer; placing at least one of an item of the items within the at least one hidden drawer; shutting the at least one hidden drawer; and selectively locking the at least one hidden drawer with the opener.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a secret storage dresser, constructed and operative according to the teachings of the present disclosure.

FIG. 1 is a side-front perspective view of the dresser during an ‘in-use’ condition, according to an embodiment of the disclosure.

FIG. 2 is a front perspective view of the dresser of FIG. 1, according to an embodiment of the present disclosure.

FIG. 3 is a side-front perspective view of the dresser of FIG. 1, according to an embodiment of the present disclosure.

FIG. 4A is a side perspective view of the dresser of FIG. 1, according to an embodiment of the present disclosure.

FIG. 4B is a front perspective view of the dresser of FIG. 1, according to an embodiment of the present disclosure.

FIG. 5A is a front perspective view of the dresser of FIG. 1, according to an embodiment of the present disclosure.

FIG. 5B is a front perspective view of the dresser of FIG. 1, according to an embodiment of the present disclosure.

FIG. 6 is a front perspective view of the dresser of FIG. 1, according to an embodiment of the present disclosure.

FIG. 7 is a flow diagram illustrating a method of use for dresser, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to furniture and more particularly to a secret storage dresser as used to improve the dresser with secret storage compartment.

Generally, disclosed is a dresser with a hidden compartment including various unlock methods, like biometric and key access. The present invention may virtually eliminate the need to store items in a safe, which are obvious and expensive, or stash important items elsewhere around a home. This further saves a considerable amount of time and frustration retrieving personal items. The dresser may further withstand fire and water for maximum protection and security. The dresser may hide jewelry, money, and other personal belongings in plain sight without detection or access.

The dresser may function as a normal dresser but include at least two hidden compartments. The compartments, or drawers, can be located at the top or bottom of the dresser, do not have handles, and can sit flush with the dresser, creating the appearance of wooden seams within the dresser. The drawers may further include one of two methods of opening. One method can include using a key to trigger a spring-latch and magnet system that ejects the drawers. The second method can include concealed biometric sensors, such as fingerprint scanners. Further, the dresser may be made from wood material, in various shades, having a modern look and clean finish that complements the décor of any room. The exact specifications may vary upon manufacturing.

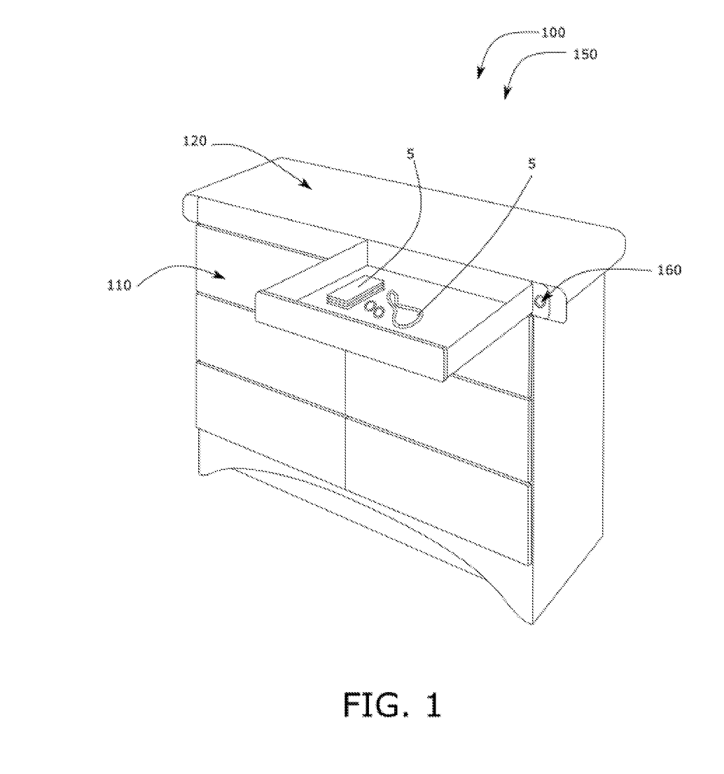

Referring now more specifically to the drawings by numerals of reference, there is shown in FIGS. 1-7, various views of a dresser 100.

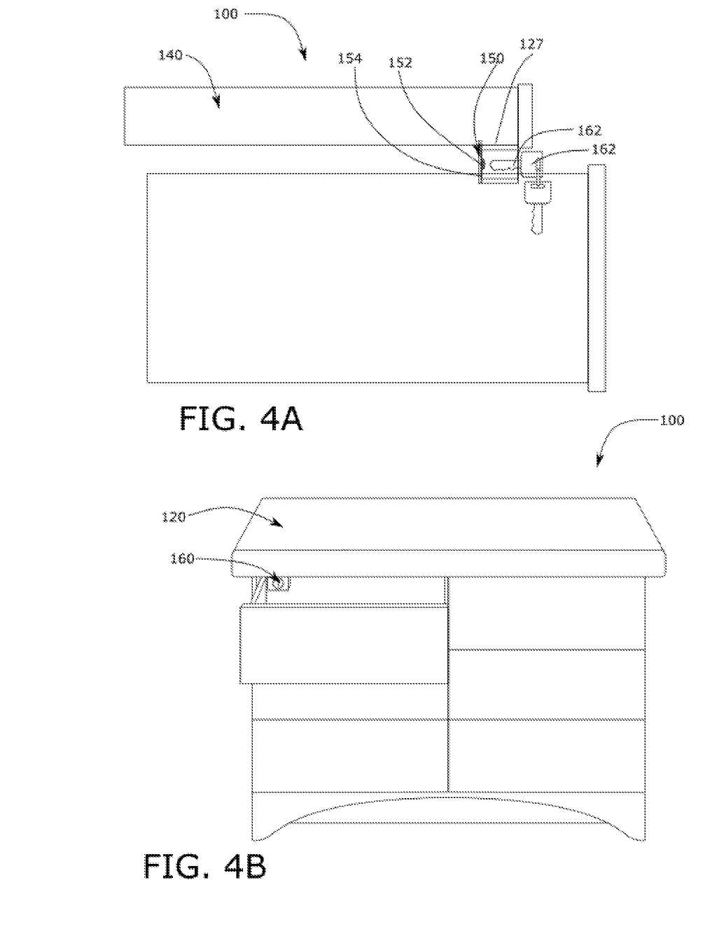

FIG. 1 shows a dresser 100 during an ‘in-use’ condition 150, according to an embodiment of the present disclosure. As illustrated, the dresser 100 may include a housing 110, a dresser-top 120, a latch-mechanism 150 (FIG. 4) and an opener 160. As shown, the dresser 100 may be used for discretely securing items 5 therein.

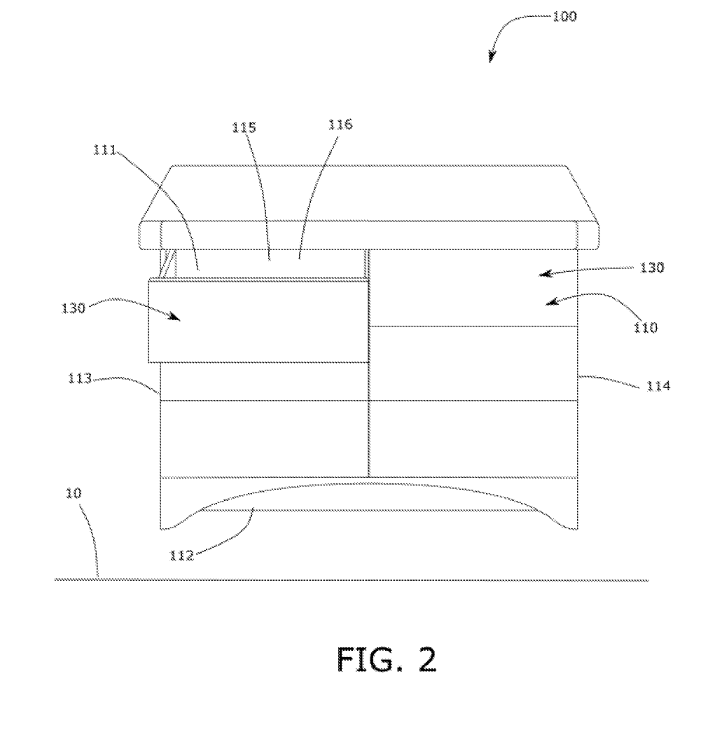

FIG. 2 shows a front perspective view of the dresser 100 of FIG. 1, according to an embodiment of the present disclosure. The housing 110 may include a first inner-capacity 111 defined by a bottom-surface 112 relative to a floor-surface 10, a second-side wall 114 opposite a first side-wall 113, a rear-wall 115 and a first open-front 116 opposite the rear-wall. As shown, the first inner-capacity 111 may be configured to slidably-receive at least two visible drawers 130 via the first open-front. In a preferred embodiment, the first inner-capacity 111 of the housing 110 may be configured to slidably-receive six visible drawers 130. However, other amounts of visible drawers 130 are contemplated. For example, the first inner-capacity 111 of the housing 110 may be configured to slidably-receive less than six visible drawers 130, or more than six visible drawers 130.

Further, the housing 110 may be made from a wood material. The wood material may be a natural wood such as maple, oak, mahogany, beech, etc. The wood material may be finished with a varnish, lacquer to provide a decorative appearance or to protect the surface of the wood material and provide added durability to prevent scratches and nicks in the wood material. In another example, the wood material may be a manufactured wood. The manufactured wood may include a top layer of natural wood covered by a coating as above. The coating may be a melamine. The melamine coating may be useful for preventing scratches and nicks in the wood, and also may be useful for preventing burning of the wood material in the event of a fire. Under the top layer of natural may be a pressed wood material such as medium density fiberboard. In this example, the cost to manufacture may be less than using natural wood. Other materials may be used.

Further, in other embodiments, the housing 110 may be made from plastic materials, metal materials, or a mix of any two of the wood materials, plastic materials and metal materials.

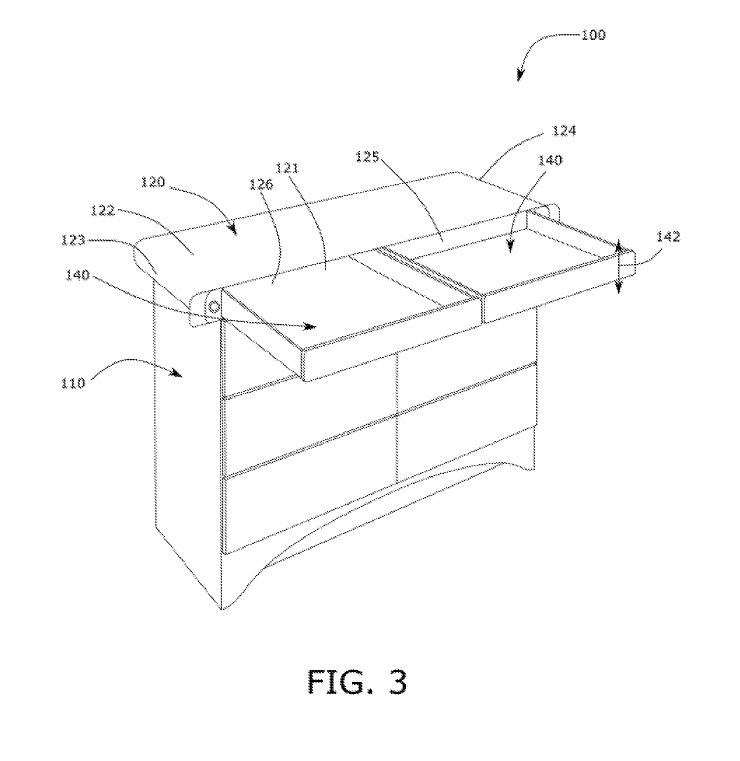

FIG. 3 shows a side-front perspective view of the dresser 100 of FIG. 1, according to an embodiment of the present disclosure. As shown, in the preferred embodiment, the dresser-top 120 may be attached to a top of the housing 110. The dresser-top 120 may include a second inner-capacity 121 defined by a top-surface 122, a first side-surface 123, a second side-surface 124 opposite the first side-surface 123, a rear-surface 125 and a second open-front 126. The inner-capacity may be configured to slidably-receive at least one hidden drawer 140 via the second open-front 126. As shown, in the preferred embodiment, the second inner-capacity 121 of the dresser-top 120 may be configured to slidably-receive two hidden drawer 140s. However, any number of hidden drawers 140 are contemplated. The two hidden drawer 140s may sit flush with the first side-surface 123, the second side-surface 124 and the top-surface 122 of the dresser-top 120 such that the two hidden drawers 140 are undetectable to anyone who is unaware of their existence.

As discussed above, the housing 110 may be made from a wood material. In the preferred embodiment, the dresser-top 120 is foreseen to be made from the same material. Further, as discussed above, the wood material may be coated with a protective composition such as melamine to protect against burning. As such, in the preferred embodiment, the at least one hidden drawer 140 may be fireproof and waterproof. This is particularly important for the hidden drawers 140, as they are foreseen to hold valuable items such as jewelry, money, computers, etc. therein. To accommodate the foreseen items, the at least one hidden drawer 140 may include a depth 142 of between 2-3 inches. However, other depths 142 are contemplated. In some embodiments, the at least one hidden drawer 140 may be manufactured in various sizes depending on user preference.

FIGS. 4A-4B show side and front perspective views of the dresser 100 of FIG. 1, according to an embodiment of the present disclosure. The latch-mechanism 150 may be attached to an inner-surface 127 of the dresser-top 120 and in communication with the at least one hidden drawer 140. The latch-mechanism 150 may be configured to selectively lock and unlock the at least one hidden drawer 140 within the second inner-capacity 121. In the preferred embodiment, the latch-mechanism 150 may include a spring-latch 152 and a magnet-system 154 configured to eject the at least one hidden drawer 140 when the latch-mechanism 150 is actuated.

Further, as shown, the opener 160 may be attached to the dresser-top 120 and in communication with the latch-mechanism 150. The opener 160 may be configured to actuate the latch-mechanism 150 to selectively unlock the at least one hidden drawer 140. In one embodiment, the opener 160 may be located within at least one of the at least two visible drawers 130. Further, as shown, in one embodiment the opener 160 may include a lock and key mechanism 162, whereby the lock is connected to the latch-mechanism 150. Upon insertion of the key into the lock, the spring-latch 152 and the magnet-system 154 may eject the at least one hidden drawer 140.

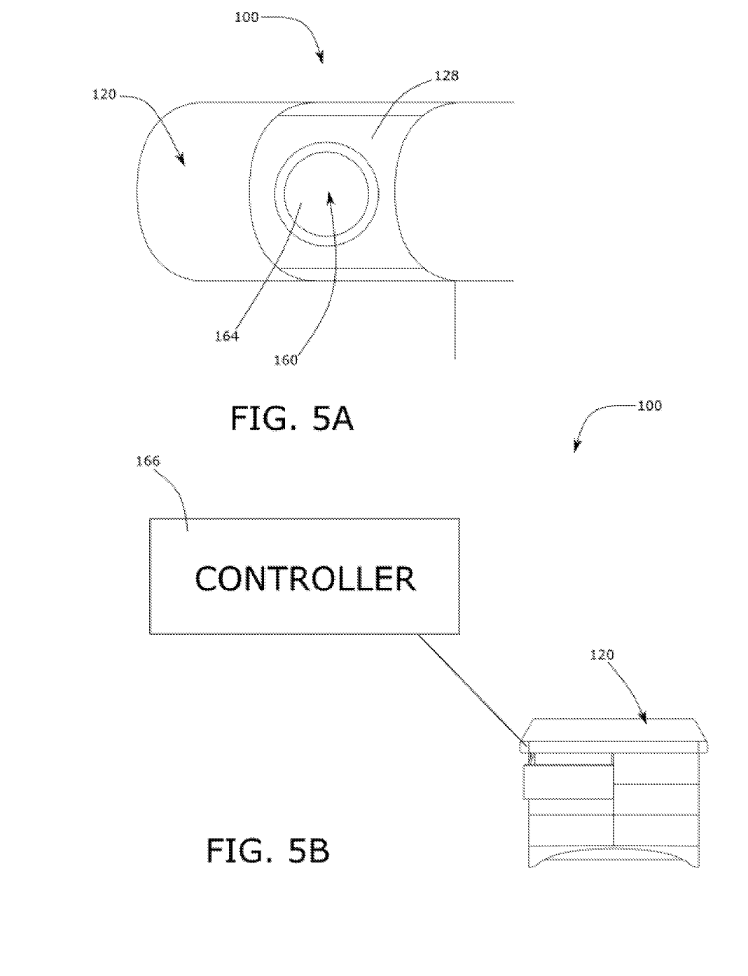

FIGS. 5A-5B show front perspective views of the dresser 100 of FIG. 1, according to an embodiment of the present disclosure. As shown here, in another embodiment, the opener 160 may be located on a front-surface 128 of the dresser-top 120. In this embodiment, the opener 160 is preferably hidden until revealed by the user of the dresser. Further, in one embodiment, the opener 160 may include a biometric sensor 164. The biometric sensor 164 may include a fingerprint scanner, a face recognition scanner or an iris recognition scanner. Other biometric sensors 164 are also contemplated. For example, DNA, retina, palm print, odor, voice, etc. It should also be appreciated that any future advancements in biometric sensor 164 technology may also be included.

In addition, in this embodiment, the dresser may further include a controller 166 communicably coupled to the opener 160 and configured to recognize an input at the biometric sensor 164 and output a command. For example, the biometric sensor 164 may receive an input such as a fingerprint on the fingerprint scanner, compare the fingerprint with a correct fingerprint in a memory of the controller 166, verify whether the fingerprint is a match, and then actuate the latch-mechanism 150 (FIG. 4A) to open the at least one hidden drawer 140 (FIG. 4A) if it is a match. If the fingerprint is not a match, the controller 166 may output an alert such as an audible alarm, or silent alarm to another room or a remote device accessible to the user. For example, a notification on a smartphone.

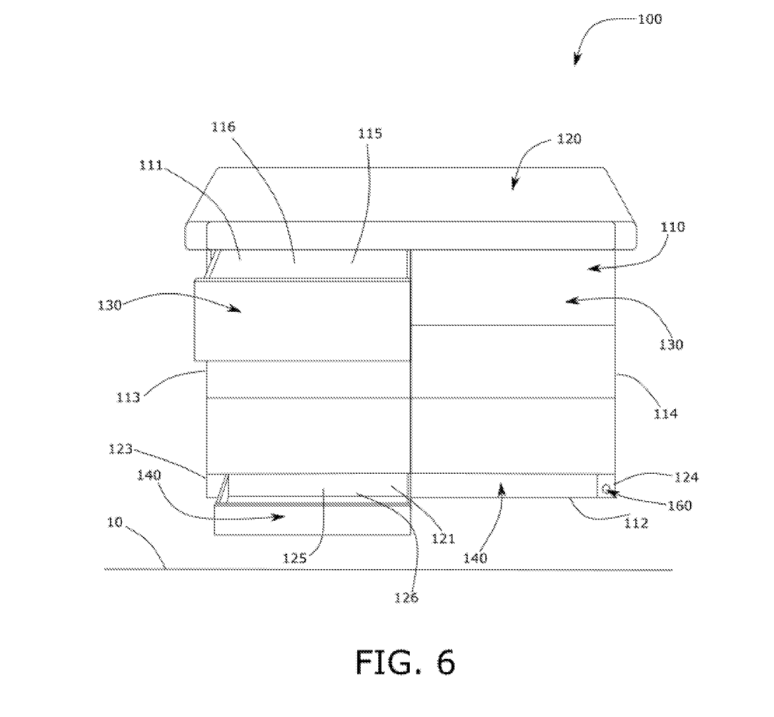

FIG. 6 shows a front perspective view of the dresser 100 of FIG. 1, according to an alternative embodiment of the present disclosure. In this embodiment, the housing 110 may include the first inner-capacity 111 defined by the bottom-surface 112 relative to the floor-surface 10, the second-side wall 114 opposite the first side-wall 113, the rear-wall 115 and the first open-front 116 opposite the rear-wall 115; and the first inner-capacity 111 may be configured to slidably-receive at least two visible drawers 130 via the first open-front. In this embodiment, the dresser may include a dresser-bottom (rather than the dresser-top 120 discussed above). As shown, the dresser-bottom may be attached to the bottom-surface 112 of the housing 110, the dresser-bottom including the second inner-capacity 121 defined by the bottom-surface 112, the first side-surface 123, a second side-surface 124 opposite the first side-surface 123, the rear-surface 125 and the second open-front 126, and the inner-capacity may be configured to slidably-receive the at least one hidden drawer 140 via the second open-front 126.

Further, the latch-mechanism 150 (FIG. 4A) may be attached to an inner-surface 127 of the dresser-bottom and in communication with the at least one hidden drawer 140; the latch-mechanism 150 configured to selectively lock and unlock the at least one hidden drawer 140 within the second inner-capacity 121. In addition, the opener 160 may be attached to the dresser-bottom and in communication with the latch-mechanism 150; the opener 160 being configured to actuate the latch-mechanism 150 (FIG. 4A) to selectively unlock the at least one hidden drawer 140.

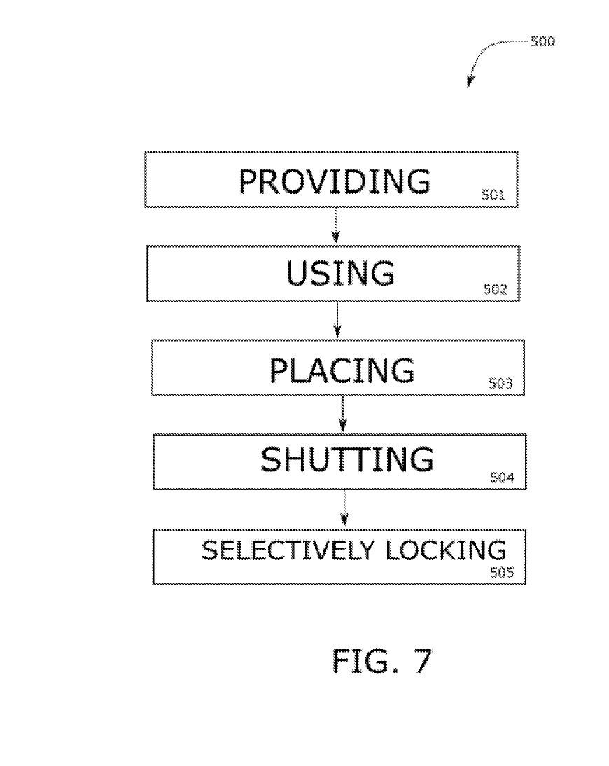

FIG. 7 is a flow diagram illustrating a method of using a dresser for discretely securing items therein 700, according to an embodiment of the present disclosure. As illustrated, the method of using a dresser for discretely securing items therein 700 may include the steps of: step one 701, providing the dresser 100 as above; step two 702, using the opener 160 to actuate the latch-mechanism 150 to selectively unlock the at least one hidden drawer 140; step three 703, placing at least one of an item of the items 5 within the at least one hidden drawer 140; step four 704, shutting the at least one hidden drawer 140; and step five 705, selectively locking the at least one hidden drawer 140 with the opener 160.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for dresser 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A dresser for discretely securing items therein, the dresser comprising:
a housing including a first inner-capacity, the first inner-capacity being defined by a bottom-surface relative to a floor-surface, a first-side wall, a second-side wall opposite the first side-wall, a rear-wall, and a first open-front opposite the rear-wall, and wherein the first inner-capacity is configured to slidably-receive at least two visible drawers via the first open-front;
a dresser-top attached to a top of the housing, the dresser-top including a second inner-capacity defined by a top-surface, a first side-surface, a second side-surface opposite the first side-surface, a rear-surface and a second open-front opposite the rear-surface, and wherein the second inner-capacity is configured to slidably-receive at least one hidden drawer via the second open-front;
a latch-mechanism attached to an inner-surface of the dresser-top and in communication with the at least one hidden drawer, the latch-mechanism configured to selectively lock and unlock the at least one hidden drawer within the second inner-capacity; and
an opener attached to the dresser-top and in communication with the latch-mechanism, the opener being configured to actuate the latch-mechanism to selectively unlock the at least one hidden drawer.

2. The dresser of claim 1, wherein the first inner-capacity of the housing is configured to slidably-receive six visible drawers.

3. The dresser of claim 1, wherein the second inner-capacity of the dresser-top is configured to slidably-receive two hidden drawers.

4. The dresser of claim 3, wherein the two hidden drawers sit flush with the first side-surface, the second side-surface and the top-surface of the dresser-top.

5. The dresser of claim 1, wherein the opener is located on a front-surface of the dresser-top.

6. The dresser of claim 1, wherein the opener is located within at least one of the at least two visible drawers.

7. The dresser of claim 1, wherein the opener includes a lock and key mechanism.

8. The dresser of claim 1, wherein the opener includes a biometric sensor.

9. The dresser of claim 8, further comprising a controller communicably coupled to the opener.

10. The dresser of claim 8, wherein the biometric sensor includes a fingerprint scanner.

11. The dresser of claim 8, wherein the biometric sensor includes a face recognition scanner.

12. The dresser of claim 8, wherein the biometric sensor includes an iris recognition scanner.

13. The dresser of claim 1, wherein the latch-mechanism includes a spring-latch.

14. The dresser of claim 13, wherein the latch-mechanism further includes a magnet-system.

15. The dresser of claim 1, wherein the at least one hidden drawer includes a depth of between 2-3 inches.

16. The dresser of claim 1, wherein the dresser is constructed of a wood material.

17. The dresser of claim 1, wherein the at least one hidden drawer is fireproof.

18. The dresser of claim 1, wherein the at least one hidden drawer is waterproof.

19. A dresser for discretely securing items therein, the dresser comprising:
a housing including a first inner-capacity, the first inner-capacity being defined by a bottom-surface relative to a floor-surface, a first-side wall, a second-side wall opposite the first side-wall, a rear-wall, and a first open-front opposite the rear-wall, and wherein the first inner-capacity is configured to slidably-receive at least two visible drawers via the first open-front;
a dresser-bottom attached to the bottom-surface of the housing, the dresser-bottom including a second inner-capacity defined by a bottom-surface, a first side-surface, a second side-surface opposite the first side-surface, a rear-surface and a second open-front opposite the rear-surface, and wherein the inner-capacity is configured to slidably-receive at least one hidden drawer via the second open-front;
a latch-mechanism attached to an inner-surface of the dresser-bottom and in communication with the at least one hidden drawer, the latch-mechanism configured to selectively lock and unlock the at least one hidden drawer within the second inner-capacity; and
an opener attached to the dresser-bottom and in communication with the latch-mechanism, the opener being configured to actuate the latch-mechanism to selectively unlock the at least one hidden drawer.

20. A method of using a dresser for discretely securing items therein, the method comprising the steps of:
providing the dresser for discretely securing the items therein, the dresser including:
a housing including a first inner-capacity, the first inner-capacity being defined by a bottom-surface relative to a floor-surface, a first-side wall, a second-side wall opposite the first side-wall, a rear-wall, and a first open-front opposite the rear-wall, and wherein the first inner-capacity is configured to slidably-receive at least two visible drawers via the first open-front;
a dresser-top attached to a top of the housing, the dresser-top including a second inner-capacity defined by a top-surface, a first side-surface, a second side-surface opposite the first side-surface, a rear-surface and a front-surface, and wherein the inner-capacity is configured to slidably-receive at least one hidden drawer via the front-surface;
a latch-mechanism attached to an inner-surface of the dresser-top and in communication with the at least one hidden drawer, the latch-mechanism configured to selectively lock and unlock the at least one hidden drawer within the second inner-capacity; and
an opener attached to the dresser-top and in communication with the latch-mechanism, the opener being configured to actuate the latch-mechanism to selectively unlock the at least one hidden drawer;
using the opener to actuate the latch-mechanism to selectively unlock the at least one hidden drawer;
placing at least one of an item of the items within the at least one hidden drawer;
shutting the at least one hidden drawer; and
selectively locking the at least one hidden drawer with the opener.
